(19) United States
(12) Patent Application Publication
(10) Pub. No.: US 2011/0281606 A1
(43) Pub. Date: Nov. 17, 2011

(54) RADIO COMMUNICATION SYSTEM, BASE STATION APPARATUS AND MOBILE STATION APPARATUS

(76) Inventors: Kazuhiro Abe, Osaka (JP); Isao Hirakawa, Osaka (JP)

(21) Appl. No.: 13/146,609

(22) PCT Filed: Dec. 10, 2009
(86) PCT No.: PCT/JP2009/070673

§ 371 Date: Jul. 27, 2011

(30) Foreign Application Priority Data
Jan. 28, 2009 (JP) 2009-016570

(51) Int. Cl. H04W 72/04

(52) U.S. Cl. 455/509

(57) ABSTRACT

A base station apparatus having eight antennas and configured to communicate with a mobile station apparatus includes: a power adjustment unit which has a function of adjusting the power of a base station apparatus specific reference signal, the power of a mobile station apparatus specific reference signal, the power of a control signal and the power of a data signal on the basis of power adjustment values shown in FIG. 5 including information on the power of the base station apparatus specific reference signal, the power of the mobile station apparatus specific reference signal, the power of the control signal and the power of the data signal; and a transmission unit which has a function of informing the mobile station apparatus of the power of the data signal. With this configuration, the base station apparatus having eight antennas can inform the mobile station apparatus of the power of the data signal.

### TECHNICAL FIELD

The present invention relates to a technique for adjusting power for communication, and a communication technique for a radio communication system, a base station apparatus, a mobile station apparatus and the like.

### BACKGROUND ART

In current mobile communications based on OFDMA (Orthogonal Frequency Division Multiple Access) system, base station apparatuses have one antenna, two antennas or four antennas. However, along with recent technological innovation and needs for improvement of communication capacity, it is expected that base station apparatuses and mobile station apparatuses will include eight antennas and employ 8×8 MIMO (Multi Input Multi Output) system in the future.

Moreover, it is also expected that diversity effect will be improved compared with conventional effect, if base station apparatuses come to include eight antennas.

For the purpose of improving cell-coverage adjustment and channel estimation accuracy to meet the above-described improvement needs, it is expected that, in the future, base station apparatuses including eight antennas will also be required to adjust the power of base station apparatus specific reference signals, and the power of mobile station apparatus specific reference signals, the power of control signals and the power of data signals.

Non-patent Document 1 describes a specification regarding the power of base station apparatus specific reference signals and the power of data signals in the case where a base station apparatus includes one antenna, two antennas or four antennas.

In Non-patent Document 1, as shown in FIG. 1 for example, the transmission power of an antenna (Ant1 in FIG. 1, for example) for transmitting base station apparatus specific reference signals (RS) in an OFDM symbol containing the base station apparatus specific reference signals (RS) is set equal to the transmission power of the antenna (Ant1 in FIG. 1, for example) in an OFDM symbol not containing any base station apparatus specific reference signals. In this case, the power of data signals in the OFDM symbol containing the base station apparatus specific reference signals is different from that in the OFDM symbol not containing any base station apparatus specific reference signals. Accordingly, in demodulating data signals, mobile station apparatuses require information on the power of the data signals.

In Non-patent Document 1, a value ρa is set for each mobile station apparatus, where the value ρa is obtained by dividing the power of data signals in an OFDM symbol not containing any base station apparatus specific reference signals by the power of base station apparatus specific reference signals; a value ρb/ρa is set for each base station apparatus where the value ρb/ρa is obtained by dividing a value ρb by ρa, and the value ρb is obtained by dividing the power of data signals in an OFDM symbol containing the base station apparatus specific reference signals by the power of base station apparatus specific reference signals, as shown in FIG. 2. Then, ρb/ρa is informed to the each base station apparatus, while ρa is informed to the each mobile station apparatus.

Moreover, as shown in FIG. 1, the power of base station apparatus specific reference signals is set to be constant, and the power of data signals is set to be constant in each resource block per OFDM symbol.

Non-patent Document 0.2 proposes that the power of data signals should be changed among antennas so that the transmission power of each of antennas (ANTP0 and ANTP1) which transmits base station apparatus specific reference signals in an OFDM symbol containing the base station apparatus specific reference signals would be equal to the transmission power of each of antennas (ANTP2 and ANTP3) which does not transmit any base station apparatus specific reference signals in an OFDM symbol, as shown in FIG. 3. This proposal has an advantage of making it possible to improve qualities such as throughput by making the most of power, while having a risk of quality deterioration as a system due to an increase in interference power between cells attributable to an increase in diversity gain.

### PRIOR ART DOCUMENTS

### Non-Patent Documents

Non-patent Document 1: 3GPP TS.36.213 ver. 8.4.0
Non-patent Document 2: 3GPP TSG RAN1 #54bis, R1-080690, “Power Scaling and DL RS boosting”

### SUMMARY OF THE INVENTION

### Problems to be Solved by the Invention

Non-patent Document 1 shows a means for informing the power of data signals from a base station apparatus to a mobile station apparatus when the base station apparatus includes one antenna, two antennas or four antennas. However, it is expected that base station apparatuses come to include eight antennas in the future; on the basis of this expectation, it is considered that a means for informing the power of data signals from a base station apparatus including eight antennas to a mobile station apparatus will be needed.

The present invention aims to provide a base station apparatus including eight antennas with a means for adjusting the power of a base station apparatus specific reference signal, the power of a mobile station apparatus specific reference signal, the power of a control signal and the power of a data signal, and a means for informing a mobile station apparatus of the power of the data signal.

### Means for Solving the Problems

An aspect of the present invention provides a communication system including a base station apparatus having eight antennas and a mobile station apparatus having one antenna or a plurality of antennas, the communication system being characterized as follows. The base station apparatus includes: a signal arrangement unit which arranges a base station apparatus specific reference signal, a mobile station apparatus specific reference signal, a control signal and a data signal in a resource block on the basis of a signal arrangement pattern showing an arrangement of the base station apparatus specific reference signal, an arrangement of the mobile station apparatus specific reference signal, an arrangement of the control signal and an arrangement of the data signal in a resource block; a power adjustment unit which adjusts a power of the base station apparatus specific reference signal, a power of the mobile station apparatus specific reference signal, a power of the control signal and a power of the data signal on the basis of a power adjustment pattern showing a power of the base station apparatus specific reference signal, a power of the mobile station apparatus specific reference signal, a power of the control signal and a power of the data signal; and a transmission unit which transmits the resource block to the mobile station apparatus. The mobile station apparatus includes: a reception unit which receives the resource block transmitted from the base station apparatus; a weight calculation unit which calculates a weight for demodulation on the basis of a channel characteristic calculated from the base station apparatus specific reference signal and the mobile station apparatus specific reference signal, and the power adjustment pattern; and a demodulation unit which demodulates the control signal and the data signal on the basis of the calculated weight.

It is preferable that each of the power of the control signal and the power of the data signal be constant in each OFDM symbol.

The power adjustment unit may adjust the power of the control signal and the power of the data signal to be transmitted from an antenna which transmits neither the base station apparatus specific reference signal nor the mobile station apparatus specific reference signal, in such a manner that a power of subcarriers used to transmit a control signal and a data signal in an OFDM symbol containing the base station apparatus specific reference signal and the mobile station specific reference signal would be constant.

It is preferable that, in the power adjustment unit, a power of subcarriers used to transmit the base station apparatus specific reference signal and the mobile station apparatus specific reference signal be constant.

It is preferable that, in the power adjustment unit, a transmission power of an antenna for transmitting the base station apparatus specific reference signal and the mobile station apparatus specific reference signal in an OFDM symbol containing the base station apparatus specific reference signal and the mobile station apparatus specific reference signal be equal to a transmission power of an antenna for an OFDM symbol containing neither the base station apparatus specific reference signal nor the mobile station apparatus specific reference signal.

It is preferable that the power adjustment unit change a power of a control signal and the power of the data signal in an OFDM symbol containing the base station apparatus specific reference signal and the mobile station apparatus specific reference signal, in accordance with a change in the power of the base station apparatus specific reference signal and the power of the mobile station apparatus specific reference signal.

It is preferable that the signal arrangement unit transmit the base station apparatus specific reference signal and the mobile station apparatus specific reference signal by use of the same subcarrier from one antenna or a plurality of the antennas simultaneously.

The base station apparatus according to the present invention may inform the mobile station apparatus of, as a mobile station apparatus specific value, the ratio of the power of the base station apparatus specific reference signal to the power of the data signal in an OFDM symbol containing neither the base station apparatus specific reference signal nor the mobile station apparatus specific reference signal.

Moreover, the base station apparatus according to the present invention may inform the mobile station apparatus of, as a base station apparatus specific value, the ratio of the power of the data signal in an OFDM symbol containing the base station apparatus specific reference signal and the mobile station apparatus specific reference signal, to the power of the data signal in an OFDM symbol containing neither the base station apparatus specific reference signal nor the mobile station apparatus specific reference signal.

Another aspect of the present invention provides a communication method for a base station apparatus having eight antennas, the method characterized by comprising: a first step of arranging a base station apparatus specific reference signal, a mobile station apparatus specific reference signal, a control signal and a data signal in a resource block, on the basis of a signal arrangement pattern showing an arrangement of the base station apparatus specific reference signal, an arrangement of the mobile station apparatus specific reference signal, an arrangement of the control signal and an arrangement of the data signal in a resource block; a second step of adjusting a power of the base station apparatus specific reference signal, a power of the mobile station apparatus specific reference signal, a power of the control signal and a power of the data signal on the basis of a power adjustment pattern showing a power of the base station apparatus specific reference signal, a power of the mobile station apparatus specific reference signal, a power of the control signal and a power of the data signal; and a third step of transmitting the resource block to the mobile station apparatus.

Moreover, provided may be a communication method for a mobile station apparatus having one antenna or a plurality of antennas, the method characterized by comprising: a first step of receiving a resource block transmitted from the base station apparatus; a second step of calculating a weight for demodulation on the basis of a channel characteristic calculated from the base station apparatus specific reference signal and the mobile station apparatus specific reference signal, and a power adjustment pattern; and a third step of demodulating a control signal and a data signal on the basis of the calculated weight.

### Effects of the Invention

According to the present invention, a base station apparatus including eight antennas adjusts therein the power of the base station apparatus specific reference signal, the power of the mobile station apparatus specific reference signal, the power of the control signal and the power of the data signal, and then informs the power of the data signal to the corresponding mobile station apparatus. Accordingly, by using the present invention, cell-coverage adjustment and channel estimation accuracy can be improved.

### BRIEF DESCRIPTION OF THE DRAWINGS

FIG. 1 is a view showing an arrangement of base station apparatus specific reference signals (RSs) and data signals.

FIG. 2 is a table showing definitions regarding the powers of base station apparatus specific reference signals and data signals.

FIG. 3 is a view showing an example of a case in which the power of data signals is changed among antennas so that the transmission power of an antenna which transmits base station apparatus specific reference signals in an OFDM symbol containing base station apparatus specific reference signals would be equal to the transmission power of an antenna which does not transmit any base station apparatus specific reference signals.

FIG. 4 is a view showing a configuration example of a base station apparatus according to an embodiment.

FIGS. 5A and 5B is a table showing arrangements of base station apparatus specific reference signals, an arrangement of mobile station apparatus specific reference signals, an arrangement of control signals and arrangement of data signals, in a resource block according to the embodiment, as well as definitions regarding the power of base station apparatus specific reference signals, the power of mobile station apparatus specific reference signals, the power of control signals and the power of data signals.

FIG. 6 is a view showing a configuration example of a mobile station apparatus according to the embodiment.

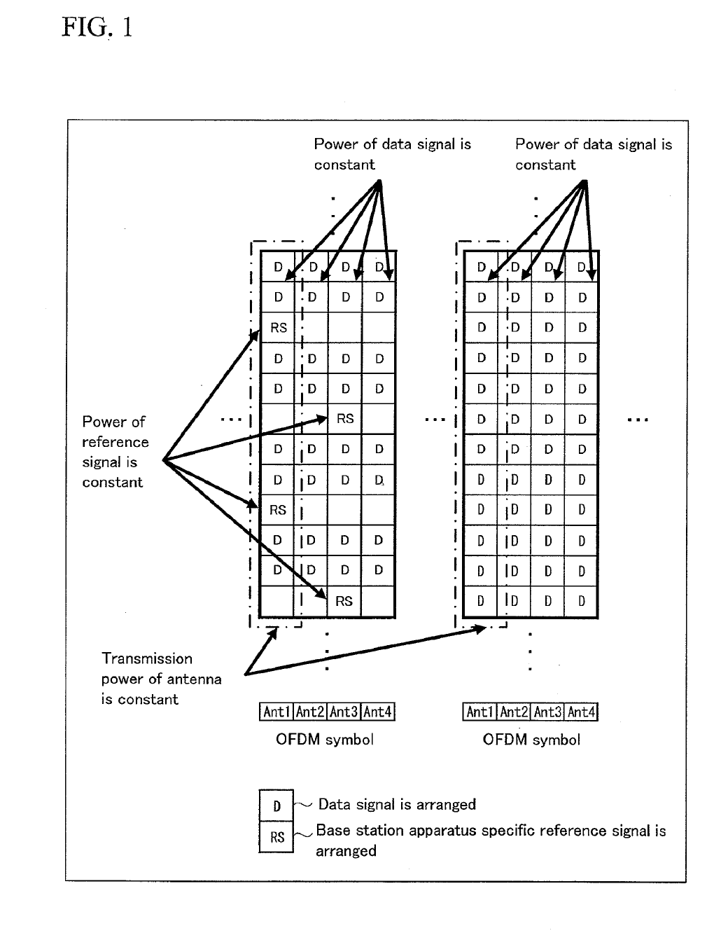

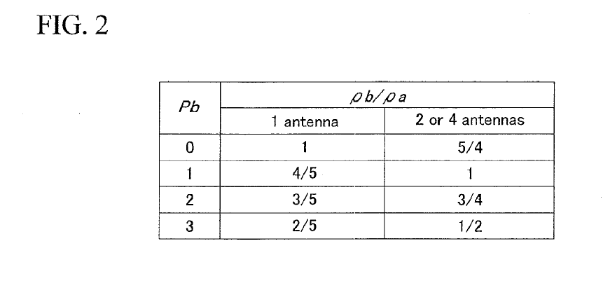

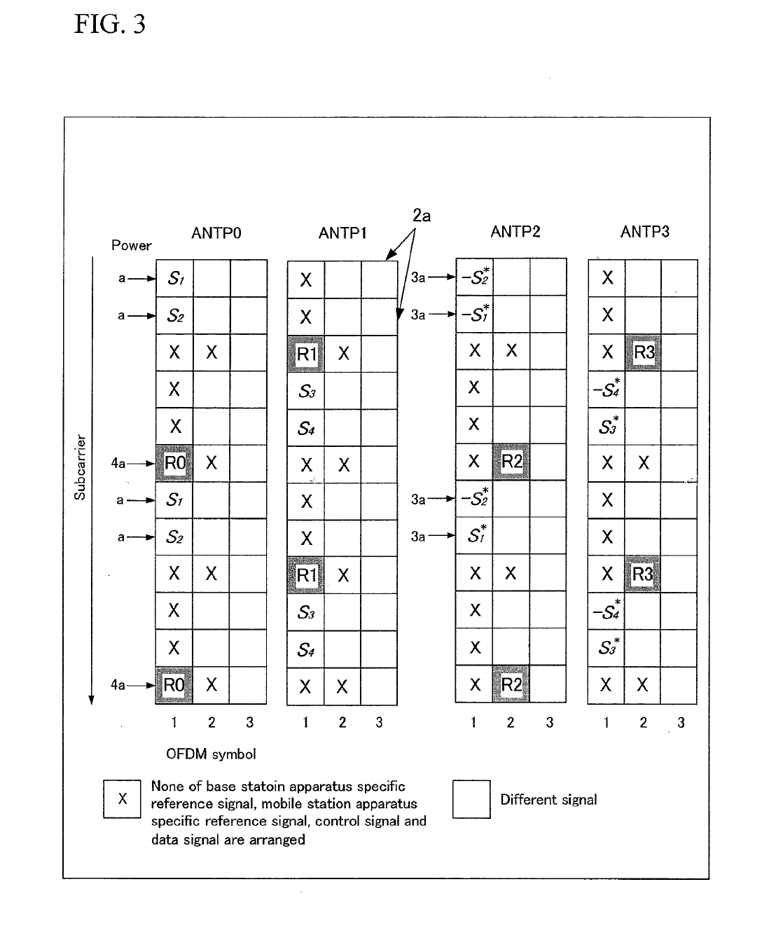

### EXPLANATION OF REFERENCE NUMERALS

(100a) base station apparatus
(10c)-(17c) signal processor
(10c-1)-(17c-1) signal arrangement unit
(10e-2)-(17c-2) power controlling unit
(10c-3)-(17c-3) transmission unit
(10c-4)-(17c-4) antenna
(200a) mobile station apparatus
(20a-1)-(27a-1) antenna
(20a-2)-(27a-2) reception unit
(20b) weight control unit
(20a-3) demodulation unit

### MODES FOR CARRYING OUT THE INVENTION

Embodiments of the present invention will be described below with reference to the drawings.

### Embodiment 1

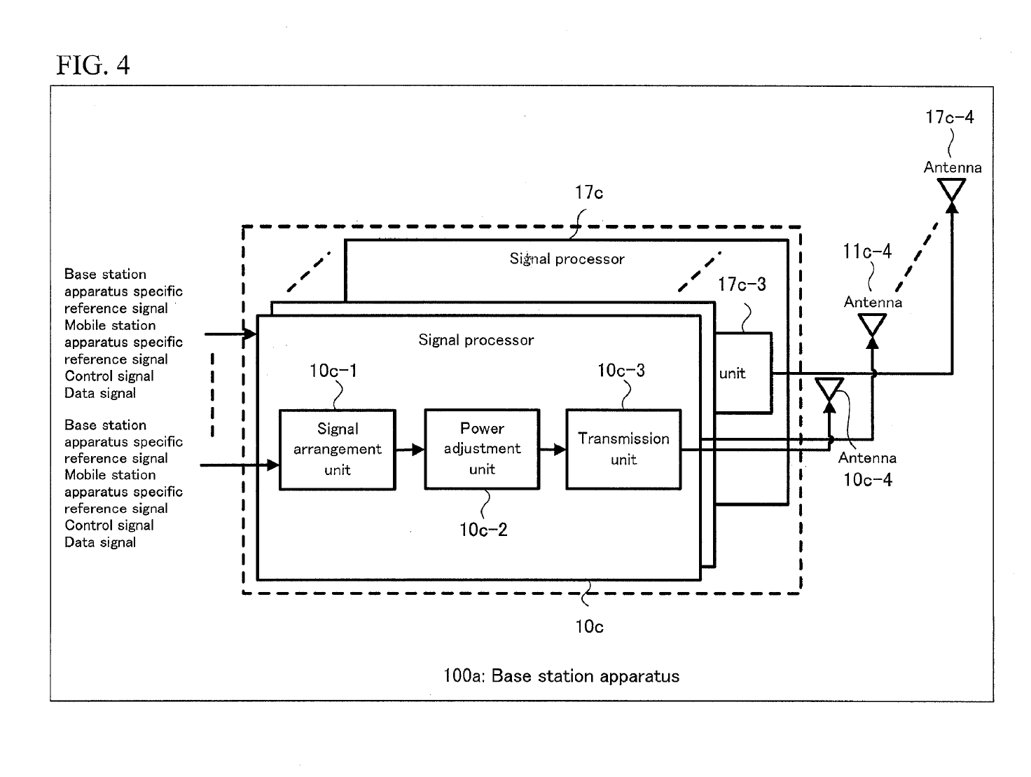

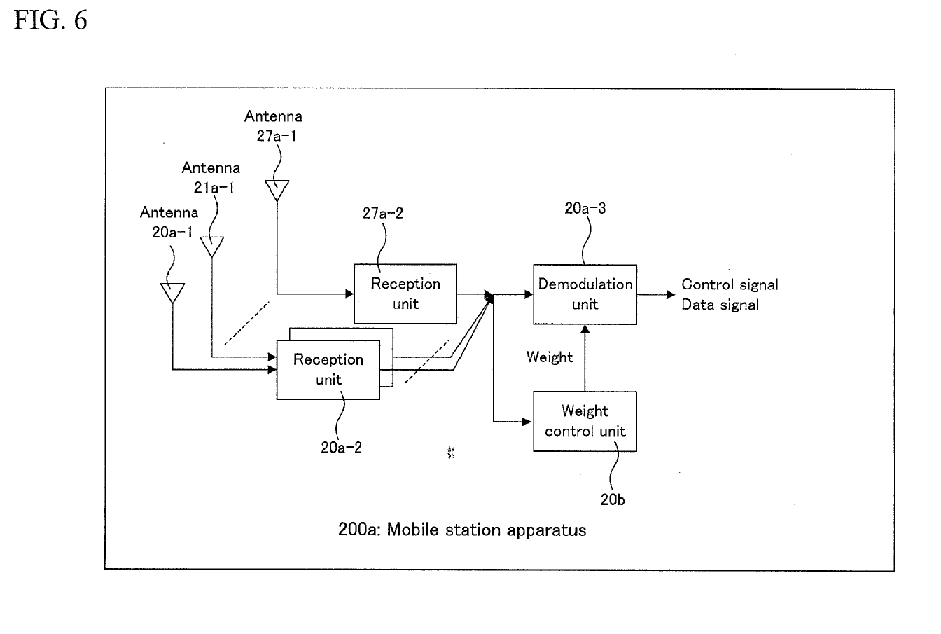

Embodiment 1 will be described by taking, as an example, communications between a base station apparatus (100a) shown in FIG. 4 and including eight antennas and a mobile station apparatus (200a) shown in FIG. 6 and including eight antennas. In this embodiment, descriptions will be given by using, as a unit, a resource block including 12 subcarriers in a frequency direction.

Firstly, a configuration example of the base station apparatus (100a) will be described.

As shown in FIG. 4, base station apparatus specific reference signals, mobile station apparatus specific reference signals, control signals and data signals are inputted from an external source to the base station apparatus (100a) according to this embodiment.

The base station apparatus (100a) includes: a signal processor (10c), a signal processor (11c), a signal processor (12c), a signal processor (13c), a signal processor (14c), a signal processor (15c), a signal processor (16c) and a signal processor (17c); and an antenna (10c-4), an antenna (11c-4), an antenna (12c-4), an antenna (13c-4), an antenna (14c-4), an antenna (15c-4), an antenna (16c-4) and an antenna (17c-4) which are connected respectively to the signal processors.

First, the signal processor (10c) receives input of base station apparatus specific reference signals, mobile station apparatus specific reference signals, control signals and data signals which are to be transmitted from the antenna (10c-4). The signal processor (11c) receives input of base station apparatus specific reference signals, mobile station apparatus specific reference signals, control signals and data signals which are to be transmitted from the antenna (11c-4). The signal processor (12c) receives input of base station apparatus specific reference signals, mobile station apparatus specific reference signals, control signals and data signals which are to be transmitted from the antenna (12c-4). The signal processor (13c) receives input of base station apparatus specific reference signals, mobile station apparatus specific reference signals, control signals and data signals which are to be transmitted from the antenna (13c-4). The signal processor (14c) receives input of base station apparatus specific reference signals, mobile station apparatus specific reference signals, control signals and data signals which are to be transmitted from the antenna (14c-4). The signal processor (15c) receives input of base station apparatus specific reference signals, mobile station apparatus specific reference signals, control signals and data signals which are to be transmitted from the antenna (15c-4). The signal processor (16c) receives input of base station apparatus specific reference signals, mobile station apparatus specific reference signals, control signals and data signals which are to be transmitted from the antenna (16c-4). The signal processor (17c) receives input of the base station apparatus specific reference signals, mobile station apparatus specific reference signals, control signals and data signals which are to be transmitted from the antenna (17c-4).

Here, since the signal processor (10c), the signal processor (11c), the signal processor (12c), the signal processor (13c), the signal processor (14c), the signal processor (15c), the signal processor (16c) and the signal processor (17c) have the same configuration, description will be given only of the signal processor (10c) in the following.

The signal processor (10c) includes a signal arrangement unit (10c-1), a power adjustment unit (10c-2) and a transmission unit (10c-3) which are arranged in this order from the input side of the base station apparatus specific reference signals, mobile station apparatus specific reference signals, control signals and data signals.

The base station apparatus specific reference signals, mobile station apparatus specific reference signals, control signals and data signals which are inputted to the signal processor (10c) are outputted to the signal arrangement unit (10c-1), first.

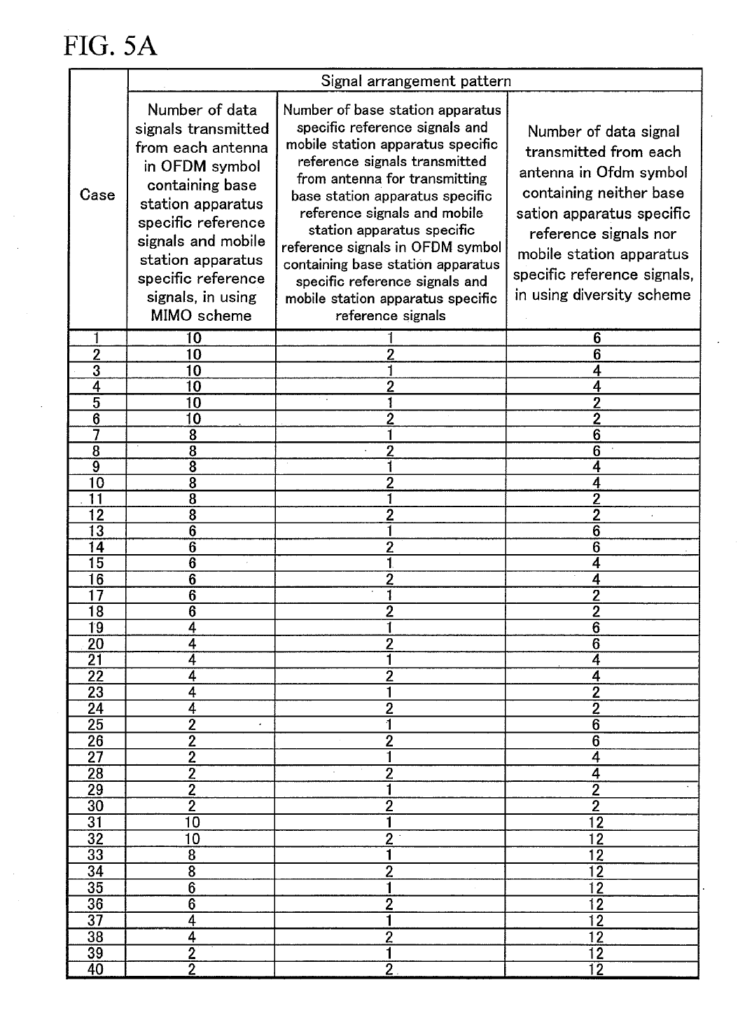

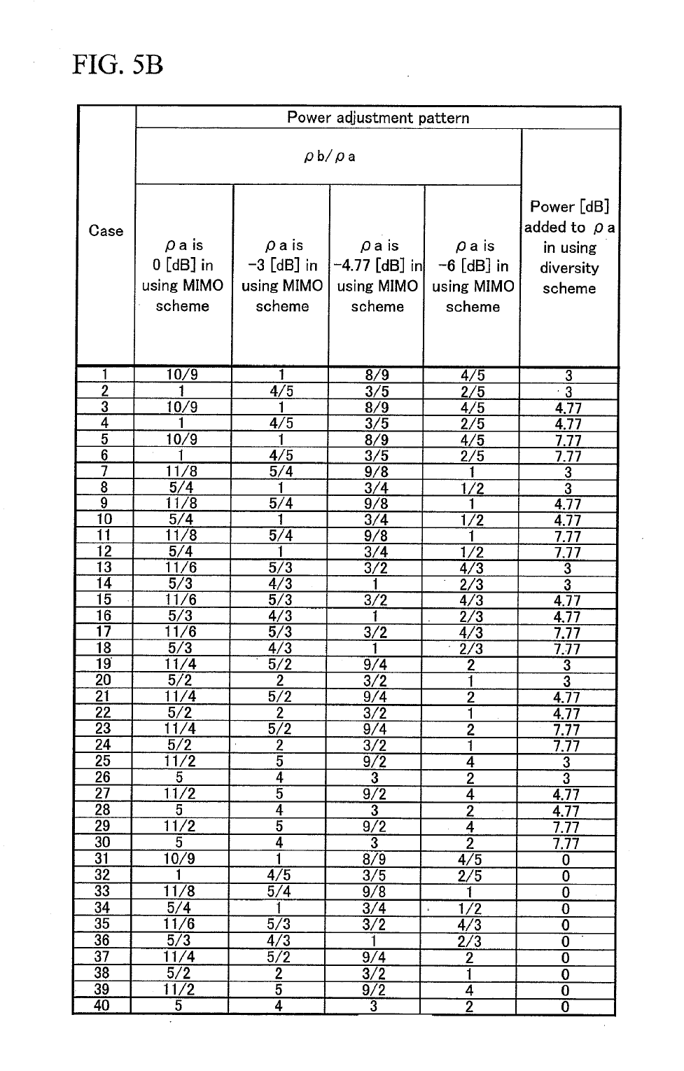

In the signal arrangement unit (10c-1), first, the base station apparatus specific reference signals, mobile station apparatus specific reference signals, control signals and data signals are arranged in a resource block on the basis of a signal arrangement pattern in any of the cases (1 to 40) shown in FIGS. 5A and 5B (Thereinafter, call FIG. 5). Here, base station apparatus specific reference signals and mobile station apparatus specific reference signals are arranged so as to be transmitted only from one antenna per subcarrier.

Specifically, first, the base station apparatus specific reference signals and mobile station apparatus specific reference signals are arranged in the resource block on the basis of the number of base station apparatus specific reference signals and mobile station apparatus specific reference signals to be transmitted from each antenna for transmitting the base station apparatus specific reference signals and mobile station apparatus specific reference signals in an OFDM symbol containing base station apparatus specific reference signals and mobile station apparatus specific reference signals.

Then, in using a diversity scheme, the control signals are arranged in the resource block on the basis of the number of data signals transmitted from each antenna in an OFDM symbol containing neither base station apparatus specific reference signals nor mobile station apparatus specific reference signals.

Subsequently, in using a MIMO scheme, the data signals are arranged in the resource block on the basis of the number of data signals transmitted from each antenna in an OFDM symbol containing base station apparatus specific reference signals and mobile station apparatus specific reference signals as well as the number of data signals (12) transmitted from each antenna in an OFDM symbol containing neither base station apparatus specific reference signals nor mobile station apparatus specific reference signals. Meanwhile, in using the diversity scheme, the data signals are arranged in the resource block on the basis of the number of data signals transmitted from each antenna in an OFDM symbol containing neither base station apparatus specific reference signals nor mobile station apparatus specific reference signals.

Thereafter, the resource block in which the base station apparatus specific reference signals, mobile station apparatus specific reference signals, control signals and data signals are arranged is outputted to the power controlling unit (10c-3).

In the power controlling unit (10c-3), first, the power of base station apparatus specific reference signals, the power of mobile station apparatus specific reference signals, the power of control signals and the power of data signals are adjusted on the basis of ρa (the value obtained by dividing the power of data signals in an OFDM symbol not containing any base station apparatus specific reference signals by the power of base station apparatus specific reference signals), ρb/ρa (the value obtained by dividing a value ρb by ρa, where the value ρb is obtained by dividing the power of data signals in an OFDM symbol containing base station apparatus specific reference signals by the power of base station apparatus specific reference signals) and the power to be added to ρa in using the diversity scheme.

Here, as mentioned above, it is assumed that the control signals are adjusted under application of a power adjustment pattern for the diversity scheme regardless of which one of the MIMO scheme and the diversity scheme is used, and that the data signals are adjusted under application of a power adjustment pattern for the MIMO scheme when the MIMO scheme is used, while are adjusted under application of the power adjustment pattern for the diversity scheme when the diversity scheme is used.

In addition, it is assumed that the power of base station apparatus specific reference signals and the power of mobile station apparatus specific reference signals are each constant and are equal to each other, and that the power of control signals and the power of data signals in an OFDM symbol are each constant.

The power adjustment patterns shown in FIGS. 5A and 5B are calculated on the basis of the signal arrangement patterns as follows.

Here, it is assumed that the total power of 12 subcarriers transmitted from one antenna is 12 a, and that each of the power of base station apparatus specific reference signals and the power of mobile station apparatus specific reference signals is 1 a when pa is 0 [dB] in using the MIMO scheme; 2 a when ρa is −3 [dB] in using the MIMO scheme; 3 a when ρa is −4.77 [dB] in using the MIMO scheme; and 4 a when ρa is −6 [dB] in using the MIMO scheme.

(Calculation Method for ρb/ρa)

A value ρb/ρa can be calculated as a power ratio equivalent to ((the total power of the 12 subcarriers transmitted from one antenna−the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals×the power of base station apparatus specific reference signals or mobile station apparatus specific reference signals)/ the number of data signals transmitted from each antenna in an OFDM symbol containing base station apparatus specific reference signals and mobile station apparatus specific reference signals, in using the MIMO scheme/the power of base station apparatus specific reference signals and the power of mobile station apparatus specific reference signals)/ρa.

### (Calculation Method for Power to be Added to ρa in Using Diversity Scheme)

The power can be calculated as the power of base station apparatus specific reference signals or mobile station apparatus specific reference signals when 10×log (the total power of the 12 subcarriers transmitted from one antenna/the number of data signals transmitted from each antenna in an OFDM symbol containing neither base station apparatus specific reference signals nor mobile station apparatus specific reference signals, in using the diversity scheme)/ρa is 0 [dB].

For example, in Case 1 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 10/9; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 8/9; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅘.

In addition, when ρb/ρa is 10/9, ρa is 0 [dB] in using the MIMO scheme, while being 3 [dB] in using the diversity scheme since 3 [dB] is added to 0 [dB]; when ρb/ρa is 1, ρa is −3 [dB] in using the MIMO scheme, while being 0 [dB] in using the diversity scheme since 3 [dB] is added to −3 [dB]; when ρb/ρa is 8/9, ρa is −4.77 [dB] in using the MIMO scheme, while being −1.77 [dB] in using the diversity scheme since 3 [dB] is added to −4.77 [dB]; and when ρb/ρa is ⅘, ρa is −6 [dB] in using the MIMO scheme, while being −3 [dB] in using the diversity scheme since 3 [dB] is added to −6 [dB].

In another example, in Case 2 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is ⅘; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ⅗; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅖.

In addition, when ρb/ρa is 1, ρa is 0 [dB] in using the MIMO scheme, while being 3 [dB] in using the diversity scheme since 3 [dB] is added to 0 [dB]; when ρb/ρa is ⅘, ρa is −3 [dB] in using the MIMO scheme, while being 0 [dB] in using the diversity scheme since 3 [dB] is added to −3 [dB]; when ρb/ρa is ⅗, ρa is −4.77 [dB] in using the MIMO scheme, while being −1.77 [dB] in using the diversity scheme since 3 [dB] is added to −4.77 [dB]; and when ρb/ρa is ⅖, ρa is −6 [dB] in using the MIMO scheme, while being −3 [dB] in using the diversity scheme since 3 [dB] is added to −6 [dB].

In another example, in Case 3 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 10/9; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 8/9; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅘.

In addition, when ρb/ρa is 10/9, ρa is 0 [dB] in using the MIMO scheme, while being 4.77 [dB] in using the diversity scheme since 4.77 [dB] is added to 0 [dB]; when ρb/ρa is 1, ρa is −3 [dB] in using the MIMO scheme, while being 1.77 [dB] in using the diversity scheme since 4.77 [dB] is added to −3 [dB]; when ρb/ρa is 8/9, ρa is −4.77 [dB] in using the MIMO scheme, while being 0 [dB] in using the diversity scheme since 4.77 [dB] is added to −4.77 [dB]; and when ρb/ρa is ⅘, ρa is −6 [dB] in using the MIMO scheme, while being -1.23 [dB] in using the diversity scheme since 4.77 [dB] is added to −6 [dB].

In another example, in Case 4 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is ⅘; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ⅗; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅖.

In addition, when ρb/ρa is 1, ρa is 0 [dB] in using the MIMO scheme, while being 4.77 [dB] in using the diversity scheme since 4.77 [dB] is added to 0 [dB]; when ρb/ρa is ⅘, ρa is −3 [dB] in using the MIMO scheme, while being 1.77 [dB] in using the diversity scheme since 4.77 [dB] is added to −3 [dB]; when ρb/ρa is ⅗, ρa is −4.77 [dB] in using the MIMO scheme, while being 0 [dB] in using the diversity scheme since 4.77 [dB] is added to −4.77 [dB]; and when ρb/ρa is ⅖, ρa is −6 [dB] in using the MIMO scheme, while being −1.23 [dB] in using the diversity scheme since 4.77 [dB] is added to −6 [dB].

In another example, in Case 5 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 10/9; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [d13] higher than the power of data signals in an OFDM symbol containing neither base station apparatus specific reference signals nor mobile station apparatus specific reference signals, in using the MIMO scheme, ρb/ρa is 8/9; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅘.

In addition, when ρb/ρa is 10/9, ρa is 0 [dB] in using the MIMO scheme, while being 7.77 [dB] in using the diversity scheme since 7.77 [dB] is added to 0 [dB]; when ρb/ρa is 1, ρa is −3 [dB] in using the MIMO scheme, while being 4.77 [dB] in using the diversity scheme since 7.77 [dB] is added to −3 [dB]; when ρb/ρa is 8/9, ρa is −4.77 [dB] in using the MIMO scheme, while being 3 [dB] in using the diversity scheme since 7.77 [dB] is added to −4.77 [dB]; and when ρb/ρa is ⅘, ρa is −6 [dB] in using the MIMO scheme, while being 1.77 [dB] in using the diversity scheme since 7.77 [dB] is added to −6 [dB].

In another example, in Case 6 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is ⅘; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ⅗; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅖.

In addition, when ρb/ρa is 1, ρa is 0 [dB] in using the MIMO scheme, while being 7.77 [dB] in using the diversity scheme since 7.77 [dB] is added to 0 [dB]; when ρb/ρa is ⅘, ρa is −3 [dB] in using the MIMO scheme, while being 4.77 [dB] in using the diversity scheme since 7.77 [dB] is added to −3 [dB]; when ρb/ρa is ⅗, ρa is −4.77 [dB] in using the MIMO scheme, while being 3 [dB] in using the diversity scheme since 7.77 [dB] is added to −4.77 [dB]; and when ρb/ρa is ⅖, ρa is −6 [dB] in using the MIMO scheme, while being 1.77 [dB] in using the diversity scheme since 7.77 [dB] is added to −6 [dB].

In another example, in Case 7 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/8; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/8; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 11/8, ρa is 0 [dB] in using the MIMO scheme, while being 3 [dB] in using the diversity scheme since 3 [dB] is added to 0 [dB]; when ρb/ρa is 5/4, ρa is −3 [dB] in using the MIMO scheme, while being 0 [dB] in using the diversity scheme since 3 [dB] is added to −3 [dB]; when ρb/ρa is 9/8, ρa is −4.77 [dB] in using the MIMO scheme, while being −1.77 [dB] in using the diversity scheme since 3 [dB] is added to −4.77 [dB]; and when ρb/ρa is 1, ρa is −6 [dB] in using the MIMO scheme, while being −3 [dB] in using the diversity scheme since 3 [dB] is added to −6 [dB].

In another example, in Case 8 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ¾; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ½.

In addition, when ρb/ρa is 5/4, ρa is 0 [dB] in using the MIMO scheme, while being 3 [dB] in using the diversity scheme since 3 [dB] is added to 0 [dB]; when ρb/ρa is 1, ρa is −3 [dB] in using the MIMO scheme, while being 0 [dB] in using the diversity scheme since 3 [dB] is added to −3 [dB]; when ρb/ρa is ¾, ρa is −4.77 [dB] in using the MIMO scheme, while being −1.77 [dB] in using the diversity scheme since 3 [dB] is added to −4.77 [dB]; and when ρb/ρa is ½, ρa is −6 [dB] in using the MIMO scheme, while being −3 [dB] in using the diversity scheme since 3 [dB] is added to −6 [dB].

In another example, in Case 9 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/8; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/8; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 11/8, ρa is 0 [dB] in using the MIMO scheme, while being 4.77 [dB] in using the diversity scheme since 4.77 [dB] is added to 0 [dB]; when ρb/ρa is 5/4, ρa is −3 [dB] in using the MIMO scheme, while being 1.77 [dB] in using the diversity scheme since 4.77 [dB] is added to −3 [dB]; when ρb/ρa is 9/8, ρa is −4.77 [dB] in using the MIMO scheme, while being 0 [dB] in using the diversity scheme since 4.77 [dB] is added to −4.77 [dB]; and when ρb/ρa is 1, ρa is −6 [dB] in using the MIMO scheme, while being −1.23 [dB] in using the diversity scheme since 4.77 [dB] is added to −6 [dB].

In another example, in Case 10 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ¾; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ½.

In addition, when ρb/ρa is 5/4, ρa is 0 [dB] in using the MIMO scheme, while being 4.77 [dB] in using the diversity scheme since 4.77 [dB] is added to 0 [dB]; when ρb/ρa is 1, ρa is −3 [dB] in using the MIMO scheme, while being 1.77 [dB] in using the diversity scheme since 4.77 [dB] is added to −3 [dB]; when ρb/ρa is ¾, ρa is −4.77 [dB] in using the MIMO scheme, while being 0 [dB] in using the diversity scheme since 4.77 [dB] is added to −4.77 [dB]; and when ρb/ρa is ½, ρa is −6 [dB] in using the MIMO scheme, while being −1.23 [dB] in using the diversity scheme since 4.77 [dB] is added to −6 [dB].

In another example, in Case 11 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/8; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/8; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 11/8, ρa is 0 [dB] in using the MIMO scheme, while being 7.77 [dB] in using the diversity scheme since 7.77 [dB] is added to 0 [dB]; when ρb/ρa is 5/4, ρa is −3 [dB] in using the MIMO scheme, while being 4.77 [dB] in using the diversity scheme since 7.77 [dB] is added to −3 [dB]; when ρb/ρa is 9/8, ρa is −4.77 [dB] in using the MIMO scheme, while being 3 [dB] in using the diversity scheme since 7.77 [dB] is added to −4.77 [dB]; and when ρb/ρa is 1, ρa is −6 [dB] in using the MIMO scheme, while being 1.77 [dB] in using the diversity scheme since 7.77 [dB] is added to −6 [dB].

In another example, in Case 12 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ¾; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ½.

In addition, when ρb/ρa is 5/4, ρa is 0 [dB] in using the MIMO scheme, while being 7.77 [dB] in using the diversity scheme since 7.77 [dB] is added to 0 [dB]; when ρb/ρa is 1, ρa is −3 [dB] in using the MIMO scheme, while being 4.77 [dB] in using the diversity scheme since 7.77 [dB] is added to −3 [dB]; when ρb/ρa is ¾, ρa is −4.77 [dB] in using the MIMO scheme, while being 3 [dB] in using the diversity scheme since 7.77 [dB] is added to −4.77 [dB]; and when ρb/ρa is ½, ρa is −6 [dB] in using the MIMO scheme, while being 1.77 [dB] in using the diversity scheme since 7.77 [dB] is added to −6 [dB].

In another example, in Case 13 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/6; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4/3.

In addition, when ρb/ρa is 11/6, ρa is 0 [dB] in using the MIMO scheme, while being 3 [dB] in using the diversity scheme since 3 [dB] is added to 0 [dB]; when ρb/ρa is 5/3, ρa is −3 [dB] in using the MIMO scheme, while being 0 [dB] in using the diversity scheme since 3 [dB] is added to −3 [dB]; when ρb/ρa is 3/2, ρa is −4.77 [dB] in using the MIMO scheme, while being −1.77 [dB] in using the diversity scheme since 3 [dB] is added to −4.77 [dB]; and when ρb/ρa is 4/3, ρa is −6 [dB] in using the MIMO scheme, while being −3 [dB] in using the diversity scheme since 3 [dB] is added to −6 [dB].

In another example, in Case 14 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 1; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅔.

In addition, when ρb/ρa is 5/3, ρa is 0 [dB] in using the MIMO scheme, while being 3 [dB] in using the diversity scheme since 3 [dB] is added to 0 [dB]; when ρb/ρa is 4/3, ρa is −3 [dB] in using the MIMO scheme, while being 0 [dB] in using the diversity scheme since 3 [dB] is added to −3 [dB]; when ρb/ρa is 1, ρa is −4.77 [dB] in using the MIMO scheme, while being −1.77 [dB] in using the diversity scheme since 3 [dB] is added to −4.77 [dB]; and when ρb/ρa is ⅔, ρa is −6 [dB] in using the MIMO scheme, while being −3 [dB] in using the diversity scheme since 3 [dB] is added to −6 [dB].

In another example, in Case 15 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/6; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4/3.

In addition, when ρb/ρa is 11/6, ρa is 0 [dB] in using the MIMO scheme, while being 4.77 [dB] in using the diversity scheme since 4.77 [dB] is added to 0 [dB]; when ρb/ρa is 5/3, ρa is −3 [dB] in using the MIMO scheme, while being 1.77 [dB] in using the diversity scheme since 4.77 [dB] is added to −3 [dB]; when ρb/ρa is 3/2, ρa is −4.77 [dB] in using the MIMO scheme, while being 0 [dB] in using the diversity scheme since 4.77 [dB] is added to −4.77 [dB]; and when ρb/ρa is 4/3, ρa is −6 [dB] in using the MIMO scheme, while being −1.23 [dB] in using the diversity scheme since 4.77 [dB] is added to −6 [dB].

In another example, in Case 16 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 1; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅔.

In addition, when ρb/ρa is 5/3, ρa is 0 [dB] in using the MIMO scheme, while being 4.77 [dB] in using the diversity scheme since 4.77 [dB] is added to 0 [dB]; when ρb/ρa is 4/3, ρa is −3 [dB] in using the MIMO scheme, while being 1.77 [dB] in using the diversity scheme since 4.77 [dB] is added to −3 [dB]; when ρb/ρa is 1, ρa is −4.77 [dB] in using the MIMO scheme, while being 0 [dB] in using the diversity scheme since 4.77 [dB] is added to −4.77 [dB]; and when ρb/ρa is ⅔, ρa is −6 [dB] in using the MIMO scheme, while being −1.23 [dB] in using the diversity scheme since 4.77 [dB] is added to −6 [dB].

In another example, in Case 17 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/6; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4/3.

In addition, when ρb/ρa is 11/6, ρa is 0 [dB] in using the MIMO scheme, while being 7.77 [dB] in using the diversity scheme since 7.77 [dB] is added to 0 [dB]; when ρb/ρa is 5/3, ρa is −3 [dB] in using the MIMO scheme, while being 4.77 [dB] in using the diversity scheme since 7.77 [dB] is added to −3 [dB]; when ρb/ρa is 3/2, ρa is −4.77 [dB] in using the MIMO scheme, while being 3 [dB] in using the diversity scheme since 7.77 [dB] is added to −4.77 [dB]; and when ρb/ρa is 4/3, ρa is −6 [dB] in using the MIMO scheme, while being 1.77 [dB] in using the diversity scheme since 7.77 [dB] is added to −6 [dB].

In another example, in Case 18 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 1; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅔.

In addition, when ρb/ρa is 5/3, ρa is 0 [dB] in using the MIMO scheme, while being 7.77 [dB] in using the diversity scheme since 7.77 [dB] is added to 0 [dB]; when ρb/ρa is 4/3, ρa is −3 [dB] in using the MIMO scheme, while being 4.77 [dB] in using the diversity scheme since 7.77 [dB] is added to −3 [dB]; when ρb/ρa is 1, ρa is −4.77 [dB] in using the MIMO scheme, while being 3 [dB] in using the diversity scheme since 7.77 [dB] is added to −4.77 [dB]; and when ρb/ρa is ⅔, ρa is −6 [dB] in using the MIMO scheme, while being 1.77 [dB] in using the diversity scheme since 7.77 [dB] is added to −6 [dB].

In another example, in Case 19 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/4; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 11/4, ρa is 0 [dB] in using the MIMO scheme, while being 3 [dB] in using the diversity scheme since 3 [dB] is added to 0 [dB]; when ρb/ρa is 5/2, ρa is −3 [dB] in using the MIMO scheme, while being 0 [dB] in using the diversity scheme since 3 [dB] is added to −3 [dB]; when ρb/ρa is 9/4, ρa is −4.77 [dB] in using the MIMO scheme, while being −1.77 [dB] in using the diversity scheme since 3 [dB] is added to −4.77 [dB]; and when ρb/ρa is 2, ρa is −6 [dB] in using the MIMO scheme, while being −3 [dB] in using the diversity scheme since 3 [dB] is added to −6 [dB].

In another example, in Case 20 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 5/2, ρa is 0 [dB] in using the MIMO scheme, while being 3 [dB] in using the diversity scheme since 3 [dB] is added to 0 [dB]; when ρb/ρa is 2, ρa is −3 [dB] in using the MIMO scheme, while being 0 [dB] in using the diversity scheme since 3 [dB] is added to −3 [dB]; when ρb/ρa is 3/2, ρa is −4.77 [dB] in using the MIMO scheme, while being −1.77 [dB] in using the diversity scheme since 3 [dB] is added to −4.77 [dB]; and when ρb/ρa is 1, ρa is −6 [dB] in using the MIMO scheme, while being −3 [dB] in using the diversity scheme since 3 [dB] is added to −6 [dB].

In another example, in Case 21 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/4; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 11/4, ρa is 0 [dB] in using the MIMO scheme, while being 4.77 [dB] in using the diversity scheme since 4.77 [dB] is added to 0 [dB]; when ρb/ρa is 5/2, ρa is −3 [dB] in using the MIMO scheme, while being 1.77 [dB] in using the diversity scheme since 4.77 [dB] is added to −3 [dB]; when ρb/ρa is 9/4, ρa is −4.77 [dB] in using the MIMO scheme, while being 0 [dB] in using the diversity scheme since 4.77 [dB] is added to −4.77 [dB]; and when ρb/ρa is 2, ρa is −6 [dB] in using the MIMO scheme, while being −1.23 [dB] in using the diversity scheme since 4.77 [dB] is added to −6 [dB].

In another example, in Case 22 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 5/2, ρa is 0 [dB] in using the MIMO scheme, while being 4.77 [dB] in using the diversity scheme since 4.77 [dB] is added to 0 [dB]; when ρb/ρa is 2, ρa is −3 [dB] in using the MIMO scheme, while being 1.77 [dB] in using the diversity scheme since 4.77 [dB] is added to −3 [dB]; when ρb/ρa is 3/2, ρa is −4.77 [dB] in using the MIMO scheme, while being 0 [dB] in using the diversity scheme since 4.77 [dB] is added to −4.77 [dB]; and when ρb/ρa is 1, ρa is −6 [dB] in using the MIMO scheme, while being −1.23 [dB] in using the diversity scheme since 4.77 [dB] is added to −6 [dB].

In another example, in Case 23 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/4; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 11/4, ρa is 0 [dB] in using the MIMO scheme, while being 7.77 [dB] in using the diversity scheme since 7.77 [dB] is added to 0 [dB]; when ρb/ρa is 5/2, ρa is −3 [dB] in using the MIMO scheme, while being 4.77 [dB] in using the diversity scheme since 7.77 [dB] is added to −3 [dB]; when ρb/ρa is 9/4, ρa is −4.77 [dB] in using the MIMO scheme, while being 3 [dB] in using the diversity scheme since 7.77 [dB] is added to −4.77 [dB]; and when ρb/ρa is 2, ρa is −6 [dB] in using the MIMO scheme, while being 1.77 [dB] in using the diversity scheme since 7.77 [dB] is added to −6 [dB].

In another example, in Case 24 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 5/2, ρa is 0 [dB] in using the MIMO scheme, while being 7.77 [dB] in using the diversity scheme since 7.77 [dB] is added to 0 [dB]; when ρb/ρa is 2, ρa is −3 [dB] in using the MIMO scheme, while being 4.77 [dB] in using the diversity scheme since 7.77 [dB] is added to −3 [dB]; when ρb/ρa is 3/2, ρa is −4.77 [dB] in using the MIMO scheme, while being 3 [dB] in using the diversity scheme since 7.77 [dB] is added to −4.77 [dB]; and when ρb/ρa is 1, ρa is −6 [dB] in using the MIMO scheme, while being 1.77 [dB] in using the diversity scheme since 7.77 [dB] is added to −6 [dB].

In another example, in Case 25 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4.

In addition, when ρb/ρa is 11/2, ρa is 0 [dB] in using the MIMO scheme, while being 3 [dB] in using the diversity scheme since 3 [dB] is added to 0 [dB]; when ρb/ρa is 5, ρa is −3 [dB] in using the MIMO scheme, while being 0 [dB] in using the diversity scheme since 3 [dB] is added to −3 [dB]; when ρb/ρa is 9/2, ρa is −4.77 [dB] in using the MIMO scheme, while being −1.77 [dB] in using the diversity scheme since 3 [dB] is added to −4.77 [dB]; and when ρb/ρa is 4, ρa is −6 [dB] in using the MIMO scheme, while being −3 [dB] in using the diversity scheme since 3 [dB] is added to −6 [dB].

In another example, in Case 26 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 6.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 5, ρa is 0 [dB] in using the MIMO scheme, while being 3 [dB] in using the diversity scheme since 3 [dB] is added to 0 [dB]; when ρb/ρa is 4, ρa is −3 [dB] in using the MIMO scheme, while being 0 [dB] in using the diversity scheme since 3 [dB] is added to −3 [dB]; when ρb/ρa is 3, ρa is −4.77 [dB] in using the MIMO scheme, while being −1.77 [dB] in using the diversity scheme since 3 [dB] is added to −4.77 [dB]; and when ρb/ρa is 2, ρa is −6 [dB] in using the MIMO scheme, while being −3 [dB] in using the diversity scheme since 3 [dB] is added to −6 [dB].

In another example, in Case 27 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4.

In addition, when ρb/ρa is 11/2, ρa is 0 [dB] in using the MIMO scheme, while being 4.77 [dB] in using the diversity scheme since 4.77 [dB] is added to 0 [dB]; when ρb/ρa is 5, ρa is −3 [dB] in using the MIMO scheme, while being 1.77 [dB] in using the diversity scheme since 4.77 [dB] is added to −3 [dB]; when ρb/ρa is 9/2, ρa is −4.77 [dB] in using the MIMO scheme, while being 0 [dB] in using the diversity scheme since 4.77 [dB] is added to −4.77 [dB]; and when ρb/ρa is 4, ρa is −6 [dB] in using the MIMO scheme, while being −1.23 [dB] in using the diversity scheme since 4.77 [dB] is added to −6 [dB].

In another example, in Case 28 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 4.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 5, ρa is 0 [dB] in using the MIMO scheme, while being 4.77 [dB] in using the diversity scheme since 4.77 [dB] is added to 0 [dB]; when ρb/ρa is 4, ρa is −3 [dB] in using the MIMO scheme, while being 1.77 [dB] in using the diversity scheme since 4.77 [dB] is added to −3 [dB]; when ρb/ρa is 3, ρa is −4.77 [dB] in using the MIMO scheme, while being 0 [dB] in using the diversity scheme since 4.77 [dB] is added to −4.77 [dB]; and when ρb/ρa is 2, ρa is −6 [dB] in using the MIMO scheme, while being −1.23 [dB] in using the diversity scheme since 4.77 [dB] is added to −6 [dB].

In another example, in Case 29 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4.

In addition, when ρb/ρa is 11/2, ρa is 0 [dB] in using the MIMO scheme, while being 7.77 [dB] in using the diversity scheme since 7.77 [dB] is added to 0 [dB]; when ρb/ρa is 5, ρa is −3 [dB] in using the MIMO scheme, while being 4.77 [dB] in using the diversity scheme since 7.77 [dB] is added to −3 [dB]; when ρb/ρa is 9/2, ρa is −4.77 [dB] in using the MIMO scheme, while being 3 [dB] in using the diversity scheme since 7.77 [dB] is added to −4.77 [dB]; and when ρb/ρa is 4, ρa is −6 [dB] in using the MIMO scheme, while being 1.77 [dB] in using the diversity scheme since 7.77 [dB] is added to −6 [dB].

In another example, in Case 30 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 2.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 5, ρa is 0 [dB] in using the MIMO scheme, while being 7.77 [dB] in using the diversity scheme since 7.77 [dB] is added to 0 [dB]; when ρb/ρa is 4, ρa is −3 [dB] in using the MIMO scheme, while being 4.77 [dB] in using the diversity scheme since 7.77 [dB] is added to −3 [dB]; when ρb/ρa is 3, ρa is −4.77 [dB] in using the MIMO scheme, while being 3 [dB] in using the diversity scheme since 7.77 [dB] is added to −4.77 [dB]; and when ρb/ρa is 2, ρa is −6 [dB] in using the MIMO scheme, while being 1.77 [dB] in using the diversity scheme since 7.77 [dB] is added to −6 [dB].

In another example, in Case 31 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 10/9; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 8/9; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅘.

In addition, when ρb/ρa is 10/9, ρa is 0 [dB] in using the MIMO scheme and in using the diversity scheme; when ρb/ρa is 1, ρa is −3 [dB] in using the MIMO scheme and in using the diversity scheme; when ρb/ρa is 8/9, ρa is −4.77 [dB] in using the MIMO scheme and in using the diversity scheme; and when ρb/ρa is ⅘, ρa is −6 [dB] in using the MIMO scheme and in using the diversity scheme.

In another example, in Case 32 in FIG. 5, in using the MIMO scheme, the number of data signals transmitted from each antenna in an OFDM symbol containing base station apparatus specific reference signals and mobile station apparatus specific reference signals is set to be 10, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is ⅘; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ⅗; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅖.

In addition, when ρb/ρa is 1, ρa is 0 [dB] in using the MIMO scheme and in using the diversity scheme; when ρb/ρa is ⅘, ρa is −3 [dB] in using the MIMO scheme and in using the diversity scheme; when ρb/ρa is ⅗, ρa is −4.77 [dB] in using the MIMO scheme and in using the diversity scheme; and when ρb/ρa is ⅖, ρa is −6 [dB] in using the MIMO scheme and in using the diversity scheme.

In another example, in Case 33 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/8; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/8; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 11/8, ρa is 0 [dB] in using the MIMO scheme and in using the diversity scheme; when ρb/ρa is 5/4, ρa is −3 [dB] in using the MIMO scheme and in using the diversity scheme; when ρb/ρa is 9/8, ρa is −4.77 [dB] in using the MIMO scheme and in using the diversity scheme; and when ρb/ρa is 1, ρa is −6 [dB] in using the MIMO scheme and in using the diversity scheme.

In another example, in Case 34 in FIG. 5, in using the MIMO scheme, the number of data signals transmitted from each antenna in an OFDM symbol containing base station apparatus specific reference signals and mobile station apparatus specific reference signals is set to be 8, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 1; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is ¾; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ½.

In addition, when ρb/ρa is 5/4, ρa is 0 [dB] in using the MIMO scheme and in using the diversity scheme; when ρb/ρa is 1, ρa is −3 [dB] in using the MIMO scheme and in using the diversity scheme; when ρb/ρa is ¾, ρa is −4.77 [dB] in using the MIMO scheme and in using the diversity scheme; and when ρb/ρa is ½, ρa is −6 [dB] in using the MIMO scheme and in using the diversity scheme.

In another example, in Case 35 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/6; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4/3.

In addition, when ρb/ρa is 11/6, ρa is 0 [dB] in using the MIMO scheme and in using the diversity scheme; when ρb/ρa is 5/3, ρa is −3 [dB] in using the MIMO scheme and in using the diversity scheme; when ρb/ρa is 3/2, ρa is −4.77 [dB] in using the MIMO scheme and in using the diversity scheme; and when ρb/ρa is 4/3, ρa is −6 [dB] in using the MIMO scheme and in using the diversity scheme.

In another example, in Case 36 in FIG. 5, in using the MIMO scheme, the number of data signals transmitted from each antenna in an OFDM symbol containing base station apparatus specific reference signals and mobile station apparatus specific reference signals is set to be 6, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/3; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 4/3; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 1; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is ⅔.

In addition, when ρb/ρa is 5/3, ρa is 0 [dB] in using the MIMO scheme and in using the diversity scheme; when ρb/ρa is 4/3, ρa is −3 [dB] in using the MIMO scheme and in using the diversity scheme; when ρb/ρa is 1, ρa is −4.77 [dB] in using the MIMO scheme and in using the diversity scheme; and when ρb/ρa is ⅔, ρa is −6 [dB] in using the MIMO scheme and in using the diversity scheme.

In another example, in Case 37 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/4; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/4; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 11/4, ρa is 0 [dB] in using the MIMO scheme and in using the diversity scheme; when ρb/ρa is 5/2, ρa is −3 [dB] in using the MIMO scheme and in using the diversity scheme; when ρb/ρa is 9/4, ρa is −4.77 [dB] in using the MIMO scheme and in using the diversity scheme; and when ρb/ρa is 2, ρa is −6 [dB] in using the MIMO scheme and in using the diversity scheme.

In another example, in Case 38 in FIG. 5, in using the MIMO scheme, the number of data signals transmitted from each antenna in an OFDM symbol containing base station apparatus specific reference signals and mobile station apparatus specific reference signals is set to be 4, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 2; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 1.

In addition, when ρb/ρa is 5/2, ρa is 0 [dB] in using the MIMO scheme and in using the diversity scheme; when ρb/ρa is 2, ρa is −3 [dB] in using the MIMO scheme and in using the diversity scheme; when ρb/ρa is 3/2, ρa is −4.77 [dB] in using the MIMO scheme and in using the diversity scheme; and when ρb/ρa is 1, ρa is −6 [dB] in using the MIMO scheme and in using the diversity scheme.

In another example, in Case 39 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 1. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 11/2; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 9/2; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 4.

In addition, when ρb/ρa is 11/2, ρa is 0 [dB] in using the MIMO scheme and in using the diversity scheme; when ρb/ρa is 5, ρa is −3 [dB] in using the MIMO scheme and in using the diversity scheme; when ρb/ρa is 9/2, ρa is −4.77 [dB] in using the MIMO scheme and in using the diversity scheme; and when ρb/ρa is 4, ρa is −6 [dB] in using the MIMO scheme and in using the diversity scheme.

In another example, in Case 40 in FIG. 5, in using the MIMO scheme, the number of data signals transmitted from each antenna in an OFDM symbol containing base station apparatus specific reference signals and mobile station apparatus specific reference signals is set to be 2, and the number of base station apparatus specific reference signals and mobile station apparatus specific reference signals transmitted from each antenna for transmitting base station apparatus specific reference signals and mobile station apparatus specific reference signals in an OFDM symbol containing base station apparatus specific reference signals and mobile station apparatus specific reference signals is set to be 2. Moreover, in using the diversity scheme, the number of data signals transmitted from each antenna in an OFDM symbol containing neither base station apparatus specific reference signals nor mobile station apparatus specific reference signals is set to be 12.

Accordingly, when each of the power of base station apparatus specific reference signals and the power of mobile station apparatus specific reference signals is set to be equal to the power of data signals in an OFDM symbol containing neither base station apparatus specific reference signals nor mobile station apparatus specific reference signals, in using the MIMO scheme, ρb/ρa is 5; when each of the power of base station apparatus specific reference signals and the power of mobile station apparatus specific reference signals is set to be 3 [dB] higher than the power of data signals in an OFDM symbol containing neither base station apparatus specific reference signals nor mobile station apparatus specific reference signals, in using the MIMO scheme, ph/pa is 4; when each of the power of base station apparatus specific reference signals and the power of mobile station apparatus specific reference signals is set to be 4.77 [dB] higher than the power of data signals in an OFDM symbol containing neither base station apparatus specific reference signals nor mobile station apparatus specific reference signals, in using the MIMO scheme, ρb/ρa is 3; and when each of the power of base station apparatus specific reference signals and the power of mobile station apparatus specific reference signals is set to be 6 [dB] higher than the power of data signals in an OFDM symbol containing neither base station apparatus specific reference signals nor mobile station apparatus specific reference signals, in using the MIMO scheme, ρb/ρa is 2.

In addition, when ρb/ρa is 5, ρa is 0 [dB] in using the MIMO scheme and in using the diversity scheme; when ρb/ρa is 4, ρa is −3 [dB] in using the MIMO scheme and in using the diversity scheme; when ρb/ρa is 3, ρa is −4.77 [dB] in using the MIMO scheme and in using the diversity scheme; and when ρb/ρa is 2, ρa is −6 [dB] in using the MIMO scheme and in using the diversity scheme.

Subsequently, the resource block including the base station apparatus specific reference signals, mobile station apparatus specific reference signals, control signals and data signals the powers of which have thus been adjusted is outputted to the transmission unit (10c-3).

The transmission unit (10c-3) transmits the inputted resource block to the mobile station apparatus (200a) via the antenna (10c-4). This means the same as the following: the signal processor (10c) transmits the resource block to the mobile station apparatus (200a) via the antenna (10c-4).

Similarly, the signal processor (11c) transmits the resource block to the mobile station (200a) via the antenna (11c-4); the signal processor (12c) transmits the resource block to the mobile station (200a) via the antenna (12c-4); the signal processor (13c) transmits the resource block to the mobile station (200a) via the antenna (13c-4); the signal processor (14c) transmits the resource block to the mobile station (200a) via the antenna (14c-4); the signal processor (15c) transmits the resource block to the mobile station (200a) via the antenna (15c-4); the signal processor (16c) transmits the resource block to the mobile station (200a) via the antenna (16c-4); and the signal processor (17c) transmits the resource block to the mobile station (200a) via the antenna (17c-4).

Next, the mobile station apparatus (200a) shown in FIG. 6 will be described.

As shown in FIG. 6, the mobile station apparatus (200a) according to this embodiment includes: an antenna (20a-1), an antenna (21a-1), an antenna (22a-1), an antenna (23a-1), an antenna (24a-1), an antenna (25a-1), an antenna (26a-1) and an antenna (27a-1); a reception unit (20a-2), a reception unit (21a-2), a reception unit (22a-2), a reception unit (23a-2), a reception unit (24a-2), a reception unit (25a-2), a reception unit (26a-2) and a reception unit (27a-2); a weight control unit (20b); and a demodulation unit (20a-3).

The reception unit (20a-2) receives, via the antenna (20a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3). Similarly, the reception unit (21a-2) receives, via the antenna (21a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3); the reception unit (22a-2) receives, via the antenna (22a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3); the reception unit (23a-2) receives, via the antenna (23a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3); the reception unit (24a-2) receives, via the antenna (24a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3); the reception unit (25a-2) receives, via the antenna (25a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3); the reception unit (26a-2) receives, via the antenna (26a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3); and the reception unit (27a-2) receives, via the antenna (27a-1) included in the mobile station apparatus (200a), the resource blocks transmitted from the antenna (10c-4), the antenna (11c-4), the antenna (12c-4), the antenna (13c-4), the antenna (14c-4), the antenna (15c-4), the antenna (16c-4) and the antenna (17c-4) included in the base station apparatus (100a), and then outputs the received resource blocks to the weight control unit (20b) and the demodulation unit (20a-3).

The weight control unit (20b) first acquires the base station apparatus specific reference signals and the mobile station apparatus specific reference signals arranged in the inputted resource blocks, on the basis of the signal arrangement pattern applied in the base station apparatus (100a).

Then, on the basis of the base station apparatus specific reference signals and the mobile station apparatus specific reference signals thus acquired, the weight control unit (20b) estimates channels between the antenna (10c-4), the antenna (11c-4), the antenna (12c-4), the antenna (13c-4), the antenna (14c-4), the antenna (15c-4), the antenna (16c-4) and the antenna (17c-4) of the base station apparatus (100a) and the antenna (20c-4), the antenna (21c-4), the antenna (22c-4), the antenna (23c-4), the antenna (24c-4), the antenna (25c-4), the antenna (26c-4) and the antenna (27c-4) of the mobile station apparatus (200a). On the basis of the channel characteristics thus estimated and the power adjustment pattern applied in the base station apparatus (100a), the demodulation unit (20a-3) calculates weights to be applied respectively to the control signals and the data signals.

On the basis of the signal arrangement pattern applied in the base station apparatus (100a) and the weights outputted from the weight control unit (20b), the demodulation unit (20a-3) acquires the control signals and the data signals arranged in the resource blocks.

Here, some of the resource blocks include a broadcast channel for informing, from the base station apparatus, information common to all the mobile station apparatus which are present in the cell covered by the base station apparatus. The above described ρb/ρa or an index indicating ρb/ρa is specified for each base station apparatus, and is informed from the base station apparatus by use of the broadcast channel. Moreover, the above described ρa or an index indicating ρa is specified for each mobile station apparatus, and is informed by use of a unicast channel for informing information specific to each mobile station apparatus, such as a control signal.

In Embodiment 1, in the base station apparatus including eight antennas, base station apparatus specific reference signals, mobile station apparatus specific reference signals and data signals are arranged in resource blocks on the basis of any of the signal arrangement patterns shown in FIG. 5, and the power of base station apparatus specific reference signals, the power of mobile station apparatus specific reference signals, the power of control signals and the power of data signals are adjusted on the basis of the corresponding power adjustment pattern. Here, it is assumed that the base station apparatus (100a) and the mobile station apparatus (200a) share the signal arrangement patterns and the power adjustment patterns.

In this way, cell-coverage adjustment and channel estimation accuracy of the base station apparatus including eight antennas can be improved.

### Embodiment 2

In Embodiment 2, the base station apparatus (100a), the mobile station apparatus (200a), the signal arrangement patterns and the power arrangement patterns shown in Embodiment 1 are used.

In Embodiment 1, the power of control signals and the power of data signals in an OFDM symbol containing base station apparatus specific reference signals and mobile station apparatus specific reference signals are set to be the same.

In Embodiment 2, by contrast, the power of control signals and the power of data signals transmitted from each antenna which transmits neither base station apparatus specific reference signals nor mobile station apparatus specific reference signals in an OFDM symbol containing base station apparatus specific reference signals and mobile station apparatus specific reference signals are adjusted, in such a manner that the power of subcarriers would always be constant.

By adjusting the powers as described above, diversity effects are improved compared with those in Embodiment 1, which improves the throughput and the like. Moreover, by thus adjusting the powers, quality deterioration due to multi-cell interference is less likely to occur compared with Non-patent Document 2 since the power of an OFDM symbol containing base station apparatus specific reference signals and mobile station apparatus specific reference signals is constantly below the maximum power per subcarrier of an OFDM symbol containing base station apparatus specific reference signals and mobile station apparatus specific reference signals in Non-patent Document 1.

Further, the power of control signals and the power of data signals transmitted from each antenna which transmits neither base station apparatus specific reference signals nor mobile station apparatus specific reference signals in an OFDM symbol containing base station apparatus specific reference signals and mobile station apparatus specific reference signals may be estimated on the basis of ρb/ρa informed from the base station apparatus to the mobile station apparatus. Alternatively, a value obtained by dividing the power of control signals and the power of data signals transmitted from each antenna which transmits neither base station apparatus specific reference signals nor mobile station apparatus specific reference signals in an OFDM symbol containing base station apparatus specific reference signals and mobile station apparatus specific reference signals by the power of control signals and the power of data signals in an OFDM symbol containing neither base station apparatus specific reference signals nor mobile station apparatus specific reference signals, or an index of the value may be set for each base station apparatus and may then be informed from the base station apparatus.

### Embodiment 3

In Embodiment 3, the base station apparatus (100a), the mobile station apparatus (200a), the signal arrangement patterns and the power adjustment patterns shown in Embodiment 1 are used.

In Embodiment 1, base station apparatus specific reference signals and mobile station apparatus specific reference signals are transmitted from one antenna only per subcarrier.

By contrast, Embodiment 3 takes, as a target, a case including two types of reference signals—first type reference signals and second type reference signals. In the case of first type reference signals, base station apparatus specific reference signals and mobile station apparatus specific reference signals are transmitted from two antennas per subcarrier, while, in the case of second type reference signals, base station apparatus specific reference signals and mobile station apparatus specific reference signals are transmitted from one antenna only.

In Embodiment 3, ρa denotes a value obtained by dividing, by the power of first type reference signals, the power of data signals in an OFDM symbol containing neither base station apparatus specific reference signals nor mobile station apparatus specific reference signals, while ρb denotes a value obtained by dividing, by the power of first type reference signals, the power of data signals transmitted from each antenna for transmitting base station apparatus specific reference signals and mobile station apparatus specific reference signals.

In addition, the power of second type reference signals is set to be twice as high as the power of first type reference signals. In Embodiment 1, only second type reference signals are used. However, by using a defined relationship between the power of first type reference signals and the power of second type reference signals even in a case using both first type reference signals and second type reference signals as in Embodiment 3, it is not necessary to inform the relationship between the power of first type reference signals and the power of data signals. Accordingly, the characteristics are obtained that the amount of informing the power of data signals is the same as that in Embodiment 1 and that the power of first type reference signals and the power of second type reference signals measured in the mobile station apparatus are the same.

As a result, the amount of informing the power of data signals does not increase even in a case which uses the diversity scheme achieving a high level of diversity effects and requires channel estimation using first type reference signals.

### Embodiment 4

In Embodiment 4, the base station apparatus (100a), the mobile station apparatus (200a), the signal arrangement patterns and the power adjustment patterns shown in Embodiment 1 are used.

Embodiment 4 takes the following case as a target. In this case, the power of control signals and the power of data signals transmitted from each antenna which transmits neither base station apparatus specific reference signals nor mobile station apparatus specific reference signals in an OFDM symbol containing base station apparatus specific reference signals and mobile station apparatus specific reference signals, are adjusted in such a manner that the power of subcarriers would be always constant, and there are two types of base station apparatus specific reference signals and mobile station apparatus specific reference signals, the first type reference signals being to be transmitted from two antennas per subcarrier, the second type reference signals being to be transmitted from one antenna only per subcarrier.

Embodiment 4 has the advantages that diversity effects are improved compared with Embodiment 2 and Embodiment 3, and that the amount of informing the power of data signals is the same as that in Embodiment 1.

In the embodiments described in this specification, if multiple of the above-described signal arrangement patterns and power adjustment patterns are applied to each resource block, the base station apparatus informs the mobile station apparatus of ρb/ρa or an index indicating ρb/ρa and ρa or an index indicating ρa of each of the applied multiple power adjustment patterns, without excess or deficiency.

For example, if both Case 1 and Case 2 in FIG. 5 are applied to resource blocks, the signal arrangement pattern and the power arrangement pattern of Case 1 are applied to part of the OFDM symbol, the signal arrangement pattern and the power adjustment pattern of Case 2 are applied to the other part of the OFDM symbols, and further the base station apparatus informs the mobile station apparatus, without excess or deficiency, of: ρb/ρa or an index indicating ρb/ρa and ρa or an index indicating ρa of Case 1; and ρb/ρa or an index indicating ρb/ρa and ρa or an index indicating ρa of Case 2.

Specifically, if 10/9 of Case 1 and 1 of Case 2 are informed as ρb/ρa, 0 [dB] is informed as ρa in using the MIMO scheme while 3 [dB] is informed as ρa in using the diversity scheme; if 1 of Case 1 and ⅘ of Case 2 are informed as ρb/ρa, −3 [dB] is informed as ρa in using the MIMO scheme while 0 [dB] is informed as ρa in using the diversity scheme; if 8/9 of Case 1 and ⅗ of Case 2 are informed as ρb/ρa, −4.77 [dB] is informed as ρa in using the MIMO scheme while −1.77 [dB] is informed as ρa in using the diversity scheme; and if ⅘ of Case 1 and ⅖ of Case 2 are informed as ρb/ρa, −6 [dB] is informed as ρa in using the MIMO scheme while −3 [dB] is informed as pa in using the diversity scheme.

Moreover, the multiple signal arrangement patterns and power adjustment patterns are shown in the embodiments described in this specification. However, these are only examples, and signal arrangement patterns and power adjustment patterns similar to these are also within the scope of the present invention.

Moreover, the mobile station apparatus specific reference signals in the embodiments described in this specification may be replaced with the base station apparatus specific reference signals. This means the same as the following: since a base station apparatus specific reference signal is always a reference signal transmitted from the base station and a mobile station apparatus specific reference signal is a reference signal transmitted for a specific mobile station apparatus, the reference signal always transmitted by the base station apparatus may be used as the reference signal transmitted for the specific mobile station apparatus.

Moreover, in the embodiments, configurations and the like are not limited to those illustrated in the accompanying drawings, and may be changed appropriately within the scope of producing the effects of the present invention. Additionally, the embodiments may be implemented with some appropriate alternations as long as the implementation does not depart from the scope of the aim of the present invention.

Moreover, the processing of each of the above-described components may be implemented by recording a program for performing the functions described in the embodiments, reading the program recorded in the recording medium, onto a computer system, and thereby executing the program. Here, the term “computer system” includes an OS and hardware such as peripheral devices.

In addition, the term “computer system” also includes a home page providing environment (or a home page displaying environment) if a www system is used.

The term “computer-readable recording medium” includes a portable medium such as a flexible disk, a magneto-optical disk, a ROM, a CD-ROM or the like, and a storage device such as a hard disk which is incorporated in a computer system. Further, the term “computer-readable recording medium” also includes a medium for dynamically holding a program over a short period of time such as a network, e.g. the Internet or the like, or a communication line used in a case of transmitting a program via a communication line such as a telephone line or the like, and a medium for holding a program over a certain period of time such as a volatile memory in a computer system which serves as a server or a client during such program transmission. The program may be a program for implementing part of the above-described functions, or a program capable of implementing the functions in combination with a program already stored in the computer system.

### INDUSTRIAL APPLICABILITY

The present invention can be applied to a communication apparatus.

1. A communication system including a base station apparatus having eight antennas and a mobile station apparatus having one antenna or a plurality of antennas, the communication system characterized in that
the base station apparatus comprises:
a signal arrangement unit which arranges a base station apparatus specific reference signal, a mobile station apparatus specific reference signal, a control signal and a data signal in a resource block on the basis of a signal arrangement pattern showing an arrangement of the base station apparatus specific reference signal, an arrangement of the mobile station apparatus specific reference signal, an arrangement of the control signal and an arrangement of the data signal in a resource block;
a power adjustment unit which adjusts a power of the base station apparatus specific reference signal, a power of the mobile station apparatus specific reference signals, a power of the control signal and a power of the data signal on the basis of a power adjustment pattern showing a power of the base station apparatus specific reference signal, a power of the mobile station apparatus specific reference signal, a power of the control signal and a power of the data signal; and
a transmission unit which transmits the resource block to the mobile station apparatus, and
the mobile station apparatus comprises:
a reception unit which receives the resource block transmitted from the base station apparatus;
a weight calculation unit which calculates a weight for demodulation on the basis of a channel characteristic calculated from the base station apparatus specific reference signal and the mobile station apparatus specific reference signal, and the power adjustment pattern; and
a demodulation unit which demodulates the control signal and the data signal on the basis of the calculated weight.

2. The communication system according to claim 1, characterized in that each of the power of the control signal and the power of the data signal is constant in each OFDM symbol.

3. The communication system according to claim 1, characterized in that, in the power adjustment unit, a power of subcarriers used to transmit the base station apparatus specific reference signal and the mobile station apparatus specific reference signal is constant.

4. The communication system according to claim 1, characterized in that, in the power adjustment unit, a transmission power of an antenna for transmitting the base station apparatus specific reference signal and the mobile station apparatus specific reference signal in an OFDM symbol containing the base station apparatus specific reference signal and the mobile station apparatus specific reference signal, is equal to a transmission power of an antenna for an OFDM symbol containing neither the base station apparatus specific reference signal nor the mobile station apparatus specific reference signal.

5. The communication system according to claim 1, characterized in that the power adjustment unit changes the power of the control signal and the power of the data signal in an OFDM symbol containing the base station apparatus specific reference signal and the mobile station apparatus specific reference signal, in accordance with a change in the power of the base station apparatus specific reference signal and the power of the mobile station apparatus specific reference signal.

6. The communication system according to claim 1, characterized in that the power adjustment unit adjusts the power of the control signal and the power of the data signal to be transmitted from an antenna which transmits neither the base station apparatus specific reference signal nor the mobile station apparatus specific reference signal, in such a manner that a power of subcarriers used to transmit the control signal and the data signal in an OFDM symbol containing the base station apparatus specific reference signal and the mobile station specific reference signal would be constant.

7. The communication system according to claim 1, characterized in that the signal arrangement unit transmits the base station apparatus specific reference signal and the mobile station apparatus specific reference signal by use of the same subcarrier from one antenna or a plurality of the antennas simultaneously.

8. The base station apparatus in the communication system according to claim 1, characterized in that the base station apparatus informs the mobile station apparatus of, as a base station apparatus specific value, the ratio of the power of the data signal in an OFDM symbol containing the base station apparatus specific reference signal and the mobile station apparatus specific reference signal, to the power of the data signal in an OFDM symbol containing neither the base station apparatus specific reference signal nor the mobile station apparatus specific reference signal.

9. The base station apparatus in the communication system according to claim 1, characterized in that the base station apparatus informs the mobile station apparatus of, as a mobile station apparatus specific value, the ratio of the power of the base station apparatus specific reference signal to the power of the data signal in an OFDM symbol containing neither the base station apparatus specific reference signal nor the mobile station apparatus specific reference signal.

10. The base station apparatus in the communication system according to claim 1, characterized in that the base station apparatus informs the mobile station apparatus of, as a base station apparatus specific value, the ratio of the power of the data signal in an OFDM symbol containing the base station apparatus specific reference signal and the mobile station apparatus specific reference signal, to the power of the data signal in an OFDM symbol containing neither the base station apparatus specific reference signal nor the mobile station apparatus specific reference signal.

11. A communication method for a base station apparatus having eight antennas, the method characterized by comprising:
a first step of arranging a base station apparatus specific reference signal, a mobile station apparatus specific reference signal, a control signal and a data signal in a resource block, on the basis of a signal arrangement pattern showing an arrangement of the base station apparatus specific reference signal, an arrangement of the mobile station apparatus specific reference signal, an arrangement of the control signal and an arrangement of the data signal in a resource block;
a second step of adjusting a power of the base station apparatus specific reference signal, a power of the mobile station apparatus specific reference signal, a power of the control signal and a power of the data signal on the basis of a power adjustment pattern showing a power of the base station apparatus specific reference signal, a power of the mobile station apparatus specific reference signal, a power of the control signal and a power of the data signal; and
a third step of transmitting the resource block to the mobile station apparatus.

12. A communication method for a mobile station apparatus having one antenna or a plurality of antennas, the method characterized by comprising:
a first step of receiving a resource block transmitted from the base station apparatus;
a second step of calculating a weight for demodulation on the basis of a channel characteristic calculated from the base station apparatus specific reference signal and the mobile station apparatus specific reference signal, and a power adjustment pattern; and
a third step of demodulating a control signal and a data signal on the basis of the calculated weight.

13. The communication system according to claim 2, characterized in that, in the power adjustment unit, a power of subcarriers used to transmit the base station apparatus specific reference signal and the mobile station apparatus specific reference signal is constant.

14. The communication system according to claim 2, characterized in that, in the power adjustment unit, a transmission power of an antenna for transmitting the base station apparatus specific reference signal and the mobile station apparatus specific reference signal in an OFDM symbol containing the base station apparatus specific reference signal and the mobile station apparatus specific reference signal, is equal to a transmission power of an antenna for an OFDM symbol containing neither the base station apparatus specific reference signal nor the mobile station apparatus specific reference signal.

15. The communication system according to claim 3, characterized in that, in the power adjustment unit, a transmission power of an antenna for transmitting the base station apparatus specific reference signal and the mobile station apparatus specific reference signal in an OFDM symbol containing the base station apparatus specific reference signal and the mobile station apparatus specific reference signal, is equal to a transmission power of an antenna for an OFDM symbol containing neither the base station apparatus specific reference signal nor the mobile station apparatus specific reference signal.

16. The communication system according to 2, characterized in that the power adjustment unit changes the power of the control signal and the power of the data signal in an OFDM symbol containing the base station apparatus specific reference signal and the mobile station apparatus specific reference signal, in accordance with a change in the power of the base station apparatus specific reference signal and the power of the mobile station apparatus specific reference signal.

17. The communication system according to 3, characterized in that the power adjustment unit changes the power of the control signal and the power of the data signal in an OFDM symbol containing the base station apparatus specific reference signal and the mobile station apparatus specific reference signal, in accordance with a change in the power of the base station apparatus specific reference signal and the power of the mobile station apparatus specific reference signal.

18. The communication system according to 4, characterized in that the power adjustment unit changes the power of the control signal and the power of the data signal in an OFDM symbol containing the base station apparatus specific reference signal and the mobile station apparatus specific reference signal, in accordance with a change in the power of the base station apparatus specific reference signal and the power of the mobile station apparatus specific reference signal.

19. The communication system according to claim 2, characterized in that the power adjustment unit adjusts the power of the control signal and the power of the data signal to be transmitted from an antenna which transmits neither the base station apparatus specific reference signal nor the mobile station apparatus specific reference signal, in such a manner that a power of subcarriers used to transmit the control signal and the data signal in an OFDM symbol containing the base station apparatus specific reference signal and the mobile station specific reference signal would be constant.

20. The communication system according to claim 3, characterized in that the power adjustment unit adjusts the power of the control signal and the power of the data signal to be transmitted from an antenna which transmits neither the base station apparatus specific reference signal nor the mobile station apparatus specific reference signal, in such a manner that a power of subcarriers used to transmit the control signal and the data signal in an OFDM symbol containing the base station apparatus specific reference signal and the mobile station specific reference signal would be constant.
